(19) United States
(12) Patent Application Publication
(10) Pub. No.: US 2007/0046822 A1
(43) Pub. Date: Mar. 1, 2007

(54) Video processing device, video display device and method for adjustment of color in display

(75) Inventor: Toshiyuki Arisaka, Annaka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/512,104

(22) Filed: Aug. 30, 2006

(30) Foreign Application Priority Data
Aug. 31, 2005 (JP) 2005-252828

(51) Int. Cl. H04N 9/64; H04N 5/14

(52) U.S. Cl. 348/577; 348/649

(57) ABSTRACT

An embodiment of the invention, a color cursor is disposed to display a color to be obtained after a defined color is changed in a color map display to successively display the color to which the defined color is to be changed, and in a case where the changed color displayed by the color cursor is further changed, a direction in which the color cursor is to be moved is associated with a change of the color to be obtained in a case where the changed color is further changed, and displayed in the vicinity of the color map by an adjustment bar display, the adjustment bar display being output to a video display section. The color map displays, under control of a control section, an only range of the color changeable in a color range which is an adjustment range to be represented as video.

### CROSS-REFERENCE TO RELATED APPLICATIONS

This application is based upon and claims the benefit of priority from Japanese Patent Application No. 2005-252828, filed Aug. 31, 2005, the entire contents of which are incorporated herein by reference.

### BACKGROUND

1. Field

One embodiment of the invention relates to a display color adjustment method in which an arbitrary color can be adjusted in a range suitable for display of video in, for example, a television receiver capable of displaying video information, and a video display device and a program table display method to which the adjustment method is applied.

2. Description of the Related Art

There broadly prevail: a television receiver capable of displaying video; a display device capable of displaying a color image for a personal computer and the like. Needless to say, for example, a game machine and the like integrally include the display device. It is to be noted that in most cases, in the display device, an arbitrary color as a reference can be adjusted into a different color by a user.

For example, Japanese Patent Application Publication (KOKAI) No. 9-258706, a color image adjustment device is proposed in which the reference color can be changed to another specific color (reference color after changed), and additionally a color other than the designated reference color can be changed in accordance with a difference between the changed reference color and the reference color.

In the color image adjustment device described in the above publication, however, the color after adjusted cannot be known until the color is adjusted. Therefore, the adjustment is required to be repeated a plurality of times in many cases, and a time necessary for the adjustment increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a schematic block diagram of a television receiver (video display device) in accordance with an embodiment of the invention;

FIG. 2 is an exemplary flowchart showing an example of a procedure to change (adjust) a reference color by use of a video display section (or a display device) in the television receiver shown in FIG. 1 in accordance with an embodiment of the invention;

FIG. 3 is an exemplary diagram showing an example of a schematic diagram showing a display example of a color adjustment window to be displayed in a video display section (or the display device) in the television receiver shown in FIG. 1 in accordance with an embodiment of the invention;

FIG. 4 is an exemplary diagram showing an example of a schematic diagram (example of a marker onto a selected adjustment option) showing a display example of the color adjustment window to be displayed in the video display section (or the display device) in the television receiver shown in FIG. 1 in accordance with an embodiment of the invention; and

FIG. 5 is an exemplary flowchart showing an example of a schematic diagram (display example of an adjustment direction (direction in a color map in which a color is changed in accordance with an increase or a decrease of an adjustment value)) showing one display example of the color adjustment window to be displayed in the video display section (or the display device) in the television receiver shown in FIG. 1 in accordance with an embodiment of the invention.

### DETAILED DESCRIPTION

Various embodiments according to the invention will be described hereinafter with reference to the accompanying drawings. In general, according to one embodiment of the invention, a video processing device comprising: a defining section which defines an arbitrary first color as an adjustment object; a color map generating display section to generate a color map having a peripheral color of the first color to which the first color defined by the defining section is to be changed; a pointer display section present in the color map, the pointer display section being configured to display a pointer indicating a second color to which the first color defined by the defining section is to be changed; an instructing section which inputs a control signal to move the pointer in an arbitrary direction; a first video processing section which outputs a video signal to generate and display the color map generated by the color map generating section and the pointer; and a second video processing section which outputs at least one of the first color defined by the defining section in the input video and the peripheral color of the first color in a state close to at least one of the second color after adjusted and a peripheral color of the second color.

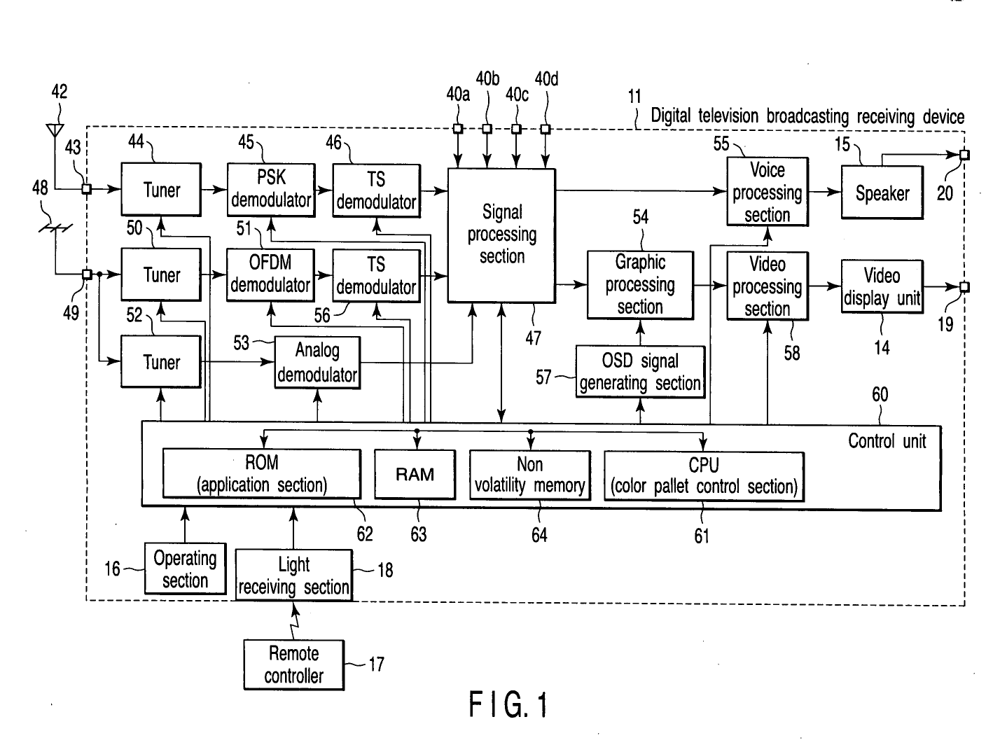

According to an embodiment, vided processing device, video display device and method for adjustment of color in display of the invention will be described in detail with reference to FIGS. 1 to 5.

FIG. 1 is a block diagram schematically showing a video display device such as a television receiving device capable of receiving, for example, broadcasting for the public.

A television broadcasting receiving device 11 has: a plane panel type video display unit 14 constituted of, for example, a surface-conduction electron-emitter display (SED) panel, a liquid crystal display panel or the like; a speaker 15; an operating section 16; a light receiving section 18 which receives operation information (input signal) to be transmitted from a remote controller 17 and the like. In the broadcasting receiving device 11, operations of units, and display and audio outputs are generally controlled by a control section (sometimes referred to as a control block or a main board) 60.

The control section 60 contains a main control IC represented by a central processing unit (CPU) 61, and controls the respective units so that operation contents are reflected which correspond to a (remote control input) control signal received from the light receiving section 18 which has received operation information (input) from the operating section 16 and operation information sent from the remote controller 17.

The control section 60 also includes: a read only memory (ROM) 62 in which, for example, a control program to be executed by the CPU 61 is held; a random access memory (RAM) 63 which supplies a working area to the CPU 61; and a non volatility memory 64 in which various types of setting information, control information and the like are stored.

It is to be noted that the broadcasting receiving device 11 has a clock (timer controller) 80 connected to the control section 60, and time management, and setting of recording reservation set in response to an input from a user are possible.

In the control section 60, there is shared a function of a color pallet control section which operates an application program stored beforehand in, for example, the ROM 62 (to execute color adjustment of the present embodiment, the color pallet control section is defined as firmware of the CPU 61).

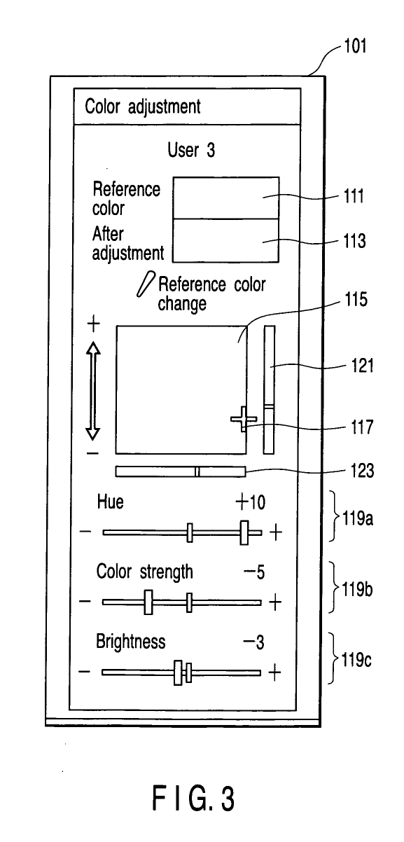

As described in a rear stage, the color pallet control section can display a color adjusted (changed) by the color adjustment described later and a color before adjusted (changed) with respect to a video signal to be output from a video processing section 58 to the video display unit 14 or an external video output 19 in a “color adjustment window” described in the rear stage with reference to FIGS. 3 to 5.

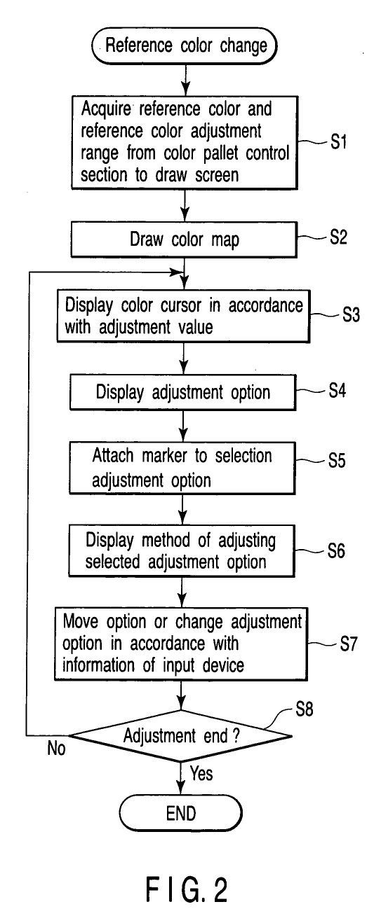

It is to be noted that in the ROM 62, there is stored a display color adjustment program (application) described later with reference to FIG. 2.

There will be described a major signal processing system of the digital television broadcasting receiving device 11.

A satellite digital television broadcasting signal received by a BS/CS digital broadcasting receiving antenna 42 is supplied to a tuner 44 for satellite digital broadcasting via an input terminal 43.

The tuner 44 selects a broadcasting signal of a desired channel in response to the control signal from the control section 60, and outputs this selected broadcasting signal to a phase shift keying (PSK) demodulator 45.

The PSK demodulator 45 demodulates the broadcasting signal selected by the tuner 44 based on the control signal from the control section 60 to obtain a transport stream including a desired program, and outputs the stream to a TS decoder 46.

In response to the control signal from the control section 60, the TS decoder 46 subjects a multiplexed transport stream (TS) signal to TS decode processing, outputs digital video and voice signals of the desired program to a signal processing section 47, and outputs, to the control section 60, various data (service information) for acquiring the program sent by the digital broadcasting, electronic program guide (EPG) information, program attribute information (program genre, etc.), subtitle information and the like.

Moreover, a ground digital television broadcasting signal received by an antenna 48 for receiving ground-based broadcasting is supplied to a tuner 50 for ground-based digital broadcasting via an input terminal 49.

In response to the control signal from the control section 60, the tuner 50 selects the broadcasting signal of the desired channel, and outputs this selected broadcasting signal to an orthogonal frequency division multiplexing (OFDM) demodulator 51.

In response to the control signal from the control section 60, the OFDM demodulator 51 demodulates the broadcasting signal selected by the tuner 50, obtains a transport stream including the desired program and outputs the stream to a TS decoder 56.

Under the control of the control section 60, the TS decoder 56 subjects a multiplexed transport stream (TS) signal to the TS decode processing, outputs digital video and voice signals of the desired program to the signal processing section 47, and outputs, to the control section 60, various data for acquiring the program sent by the digital broadcasting, electronic program guide (EPG) information, program attribute information (program genre, etc.) and the like.

A ground analog television broadcasting signal received by the antenna 48 for receiving the ground-based broadcasting is supplied to a tuner 52 for the ground-based analog broadcasting via the input terminal 49 to thereby select the broadcasting signal of the desired channel. After the broadcasting signal selected by the tuner 52 is demodulated into analog video and voice signals by an analog demodulator 53, the signals are output to the signal processing section 47.

The signal processing section 47 selectively subjects the digital video and voice signals supplied from the PSK demodulator 45 and the OFDM demodulator 51, respectively, to predetermined digital signal processing, and outputs the signals to a graphic processing section 54 and a voice processing section 55.

The signal processing section 47 is also connected to a plurality of (four in the shown example) input terminals 40a, 40b, 40c and 40d. These input terminals 40a to 40d can input the analog video and voice signals from the outside of the broadcasting receiving device 11.

The signal processing section 47 selectively digitizes the analog video and voice signals supplied from the analog demodulator 53 and the input terminals 40a to 40d, respectively, subjects the digitized video and voice signals to predetermined digital signal processing, and thereafter outputs the signals to the graphic processing section 54 and the voice processing section 55.

The graphic processing section 54 has a function of superimposing an on screen display (OSD) signal generated by an OSD signal generating section 57 on the digital video signal supplied from the signal processing section 47 to output the signal.

This graphic processing section 54 can selectively output an output video signal of the signal processing section 47 and an output OSD signal of the OSD signal generating section 57, or combine both outputs so that each output constitutes a half of a screen to output the signal.

It is to be noted that when a parameter of α-blending is set, the output OSD signal output from the OSD signal generating section 57 can be superimposed on usual video display in a “translucent” state (so that a part of a usual video signal can be transmitted), and output.

Even in one of the embodiment, needless to say, an outer frame portion (or a portion other than a “color map”) of the “color adjustment window” shown in FIGS. 3 to 5 may be displayed in the “translucent” state.

In a case where the broadcasting signal is accompanied by a subtitle signal, and a subtitle can be displayed, the graphic processing section 54 performs processing to superimpose the subtitle information on the video signal based on the control signal and the subtitle information from the control section 60.

The digital video signal output from the graphic processing section 54 is supplied to the video processing section 58.

After converting the input digital video signal into the analog video signal of a format displayable in the video display unit (display device) 14, the video processing section 58 outputs the signal to the video display unit 14 to display video, and can further output the signal to an external device (DVD recorder, etc.) connected to the output terminal 19.

After converting the input digital voice signal into the analog voice signal of a format reproducible by the speaker 15, the voice processing section 55 outputs the signal to the speaker 15 to reproduce video, and can further output the signal to the external device (headphone device, etc.) connected to an output terminal 20.

FIG. 2 is a flowchart showing a flow of the color adjustment in the television receiver shown in FIG. 1. It is to be noted that there will be described, every time needed, a video output to be output to the video display unit 14 of the television receiver shown in FIG. 1 or the external output 19, that is, the “color adjustment window” with reference to FIGS. 3 to 5.

As not described in detail, when execution of a color adjustment mode (color adjustment start) is instructed by the remote controller 17, in accordance with the program held in the ROM 62, a reference color and a reference color adjustment range in which the reference color can be adjusted (without collapsing any image) are acquired by the color pallet control section, superimposed on a predetermined range of the image displayed in the video display unit 14, and displayed as the “color adjustment window” (or the video signal including the “color adjustment window” is output to the external output 19).

As shown in FIG. 3, a “color adjustment window” 101 has a reference color display section 111 indicating an “n-th” reference color designated by the user, and the n-th color (reference color) designated by the user is displayed. In a post-adjustment display section 113, a color after adjusted (changed) and a color before adjusted (changed), designated by the user, are displayed (S1).

It is to be noted that when the color adjustment mode is activated (started), a screen to specify the color as an adjustment object is displayed in a separate routine, and the color to be designated as the adjustment object is specified by an operation of a cursor key (or a button) (not shown) of the remote controller 17. Accordingly, the “color” as the adjustment object is taken into the reference color display section 111, and displayed.

When the color as the adjustment object is specified, a color map 115 is displayed in a predetermined region of the “color adjustment window” 101 (S2).

In the color map 115, the color to which the reference color designated in the step Si has been changed is displayed as a “color cursor” 117 (S3). It is to be noted that in the “color adjustment window” 101, there are displayed as adjustment options, a scale 119a indicating a change amount of “hue”, a scale 119b indicating a change amount of “color strength” and a scale 119c indicating a change amount of “brightness”, respectively (S4).

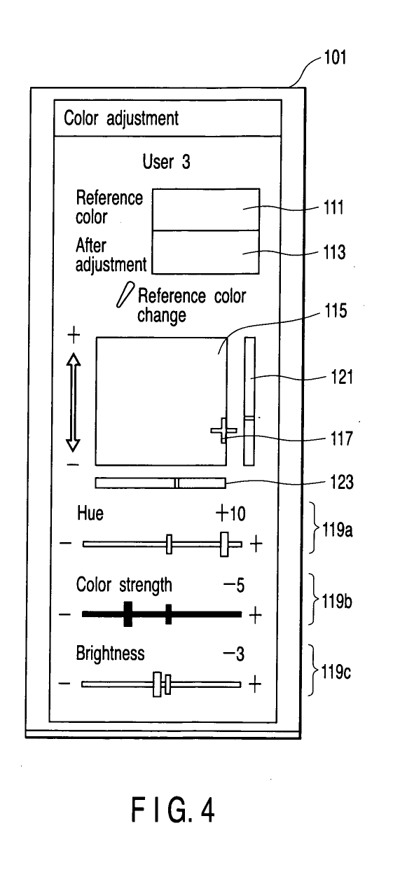

The adjustment option selected at present is displayed by a technique such as changing of the display color of the scale or positive-negative reversing. That is, a marker is attached to the selected adjustment option so that the user can recognize the option (see 5, FIG. 4).

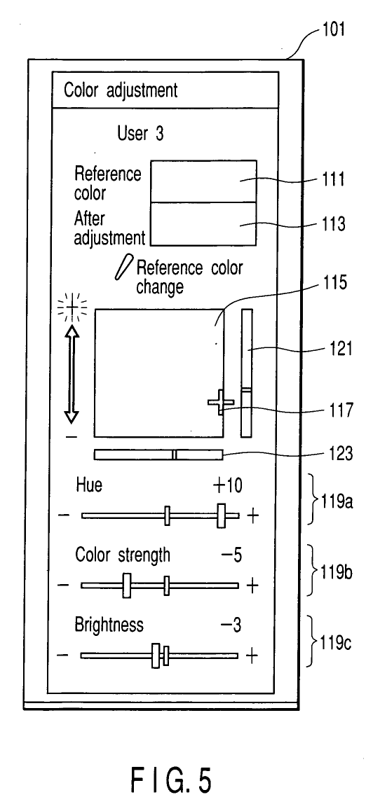

Moreover, as to the adjustment option specified in steps S4 and S5, an adjustment direction (direction in the color map in which the color is changed in accordance with an increase or a decrease of an adjustment value) is displayed by blinking or color change of “+” or “−” in each of opposite end portions of a bar graph (adjustment bar or scale) 121 or 123 changed in accordance with a change of a position of the color cursor to “left or right” or “upwardly or downwardly” in the color map (see S6, FIG. 5). In consequence, the user can easily grasp the direction in which the color cursor is to be moved so that a favorite color can be displayed.

Thereafter, in response to the user's instruction (operation of the cursor of the remote controller), the adjustment value or the adjustment option is changed in order (S7). At a time when all of user's desired colors are obtained, the processing ends or the next color can be adjusted (S8).

It is to be noted that in the application program, the reference color and the adjustment range of the reference color are acquired from the color pallet control section. In a range in which the reference color can be adjusted without any collapse, that is, so that a visually unbearable color does not appear as the video, the color map is two-dimensionally displayed which changes with, for example, the “hue” and the “color strength”.

As described above, the color to be obtained after changing the reference color acquired by the color pallet control section is displayed as the two-dimensional color map in the range in which the color can be adjusted without any collapse in the screen. Accordingly, it is possible to confirm in the screen the range up to which the reference color can be adjusted. When the adjustment option is selected so that the color cursor reaches a color portion to be adjusted, and the value is changed, user's imaged color can arbitrarily be set.

It is to be noted that in a case where the adjustable range does not exist in the color map, the reference color to be adjusted is changed to a color (peripheral color) close to a color which does not exist in the color map. Therefore, there is a possibility that the color can be adjusted into the color which has not existed in the color map.

Moreover, as to a movement direction of the color cursor, the movement direction in the color map is displayed by a direction display such as “plus” or “minus” displayed above or below, or on the left or right of the adjustment bar of the selected adjustment option. Therefore, it is possible to easily understand the adjustment option corresponding to the upward, downward, left and right movement of the color cursor, and a time required for the adjustment can be reduced (the adjustment direction can readily be known, and easily be adjusted).

It is to be noted that according to the present embodiment, the reference color after changed (change of the reference color) can independently be set by a plurality of users.

Moreover, each user can set, for example, three reference colors after changed (changes of the reference color).

Furthermore, the color range in which the reference color can be adjusted is managed in a range in which there is not any image collapse, that is, the color can be adjusted so that any visually unbearable color of the video does not appear.

Accordingly, when, for example, the reference color is changed, even another color can be adjusted to maintain a stable color balance as compared with a case where the color is changed in accordance with a difference from the reference color. Needless to say, the presently proposed color adjustment is pinpointed, and the adjustment is not reflected in the peripheral color around the adjusted reference color. However, the adjustment does not have to be necessarily pinpointed, and the peripheral color around the designated reference color can arbitrarily be changed.

It is to be noted that in the present embodiment, as a parameter for changing the reference color, the “brightness” can also be changed. In consequence, the user's favorite color can further easily be reproduced (adjusted).

In this manner, in the present embodiment, the color to be obtained after changing the reference color instructed to be changed is displayed as the two-dimensional color map set so that the only color in the predetermined range without any screen collapse can be displayed. In consequence, it is possible to confirm in the display screen the range up to which the reference color can be adjusted.

Moreover, as an adjustment method, when the adjustment option is selected so that the color cursor reaches the color portion to be adjusted, and the value is changed (the adjustment value is set), it is possible to easily set the user's imaged color.

Furthermore, the movement direction of the color cursor is displayed in accordance with the movement direction in the color map by the display “plus” or “minus” of the selected adjustment option. Therefore, since it is possible to easily confirm the adjustment option corresponding to the upward, downward, left or right movement of the color cursor, the time required for the adjustment is reduced.

Moreover, in the present specification, the video may be a still image in addition to the program of usual television broadcasting by a dynamic image and voice. The video is not necessarily limited to the video presented by the broadcasting for the public. The video may be supplied via, for example, internet or an exclusive-use line, or photographed by a camera.

As described above, when one of the embodiments of the present invention relating to the video processing device, the video display device and the display color adjustment method is used, the peripheral color to be obtained after the change of the reference color instructed to be changed is displayed as the two-dimensional color map set so that the only color in the predetermined range without any screen collapse can be displayed. In consequence, it is possible to confirm in the display screen the range up to which the reference color can be adjusted.

Moreover, as the adjustment method, when the adjustment option is selected so that the color cursor reaches the color portion to be adjusted, and the value is changed (the adjustment value is set), the user's imaged color can arbitrarily be set.

Furthermore, the movement direction of the color cursor is displayed in accordance with the movement direction in the color map by the display “plus” or “minus” of the selected adjustment option. Therefore, since it is possible to easily confirm the adjustment option corresponding to the upward, downward, left or right movement of the color cursor, the time required for the adjustment is reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing device comprising:
a defining section which defines an arbitrary first color as an adjustment object;
a color map generating display section to generate a color map having a peripheral color of the first color to which the first color defined by the defining section is to be changed;
a pointer display section present in the color map, the pointer display section being configured to display a pointer indicating a second color to which the first color defined by the defining section is to be changed;
an instructing section which inputs a control signal to move the pointer in an arbitrary direction;
a first video processing section which outputs a video signal to generate and display the color map generated by the color map generating section and the pointer; and
a second video processing section which outputs at least one of the first color defined by the defining section in the input video and the peripheral color of the first color in a state close to at least one of the second color after adjusted and a peripheral color of the second color.

2. The video processing device according to claim 1, wherein the first video processing section adjusts at least one of hue, color strength and brightness.

3. The video processing device according to claim 1, further comprising:
a scale display section to display a scale to display an adjustment option to set an adjustment value to which the pointer displayed by the pointer display section is to be moved.

4. The video processing device according to claim 1, further comprising:
an adjustment bar display section to display an adjustment bar which associates, with the movement of the color cursor, a degree of a change of the adjustment option constituting an object to be changed, when the pointer displayed by the pointer display section is moved.

5. The video processing device according to claim 3, wherein in a case where the pointer is moved along the scale display section to thereby change the color defined by the defining section, the scale display section associates the change of the defined color with a moved amount of the pointer to display the change in + or −.

6. A display color adjustment method comprising:
displaying a color specified as an adjustment object in a first display section;
displaying, in a second display section, a position where the color displayed in the first display section is positioned as a peripheral color in a color range which is an adjustment range to be represented as video; and
displaying the color corresponding to an adjustment value in the second display section in a case where the adjustment value is input.

7. The display color adjustment method according to claim 6, wherein an adjustment option which defines the adjustment value displayed in the second display section is further displayed in a third display section.

8. A video display device comprising:
a reference color display section which displays a color defined as an adjustment object;
a post-adjustment display section which displays a peripheral color after the defined color displayed in the reference color display section is adjusted;
a color map display section to display the color defined as the adjustment object until an adjustment value is input and the peripheral color after the defined color is adjusted at a time or after the adjustment value is input in a color range which is an adjustment range to be represented as video in a two-dimensional map;
a pointer display section which displays, in the color map display section, a pointer to display the color defined as the adjustment object until the adjustment value is input and the peripheral color after the defined color is adjusted at a time or after the adjustment value is input;
a first video processing section which outputs a video signal to display, in the display device, the reference color display section, the post-adjustment display section, the color map display section and the pointer display section; and
a second video processing section which outputs at least one of a first color defined by a defining section in the input video and the peripheral color of the first color in a state close to at least one of a second color after adjusted and a peripheral color of the second color.

9. The video display device according to claim 8, further comprising:
a scale display section to display a scale to display an adjustment option to set the adjustment value to which the pointer is to be moved.

10. The video display device according to claim 8, further comprising:
an adjustment bar display section to display an adjustment bar which associates, with the movement of the pointer, a degree of a change of the adjustment option constituting an object to be changed, when the pointer is moved.

11. The video display device according to claim 8, wherein the first video processing section adjusts at least one of hue, color strength and brightness.

12. The video display device according to claim 8, wherein a display output from the first video processing section is superimposed and displayed on a screen in which the color defined as the adjustment object is displayed at present.

13. The video display device according to claim 9, wherein a display output from the first video processing section is superimposed and displayed on a screen in which the color defined as the adjustment object is displayed at present.

14. The video display device according to claim 10, wherein a display output from the first video processing section is superimposed and displayed on a screen in which the color defined as the adjustment object is displayed at present.

15. The video display device according to claim 11, wherein a display output from the first video processing section is superimposed and displayed on a screen in which the color defined as the adjustment object is displayed at present.
